(19) United States
(12) Patent Application Publication
(10) Pub. No.: US 2021/0330099 A1
(43) Pub. Date: Oct. 28, 2021

(54) HANGING PLANT GROWING APPARATUS

(71) Applicant: High Caliper Growing, Inc., Oklahoma City, OK (US)

(72) Inventor: Kurt E. Reiger, Oklahoma City, OK (US)

(21) Appl. No.: 16/859,685

(22) Filed: Apr. 27, 2020

(51) Int. Cl. A47G 7/04; A01G 9/02

(52) U.S. Cl. CPC A47G 7/045; A01G 9/02

(57) ABSTRACT

A hanging plant growing apparatus is provided for growing a plant in a hanging container. The hanging plant growing apparatus comprises a frame, suspension lines, a hanging element, and a liner nested within the frame. The suspension lines have a first end and second end. The second end secures to the frame and the suspension lines extend upwardly from the frame. The first end secures to the hanging element. The liner has a plurality of pores throughout and sufficient rigidity to maintain its shape when filled with a growing medium.

### TECHNICAL FIELD

The present disclosure relates generally to hanging plant growing apparatuses, and, more particularly, to hanging plant growing containers with fabric liners configured to retain growing medium and allow the release of fluid.

### BACKGROUND

Growing plants in hanging containers is becoming an exceedingly common practice in gardening. For example, plants are grown in containers with ropes or cords attached such that the containers can be hung from a ceiling hook. However, the lack of porosity in the plastic containers causes the containers to retain moisture and absorb heat which can be to the detriment of the plant.

More often, plants are grown in open wire frames where the wire winds around and underneath forming a pocket or basket, usually about 10″ to about 16″ across and about 5″ to about 8″ deep. The wire frame attaches to a chain or cord such that it can be hung. In typical configurations, there are three or four chains of equal length attached equidistantly from one another such that the wire frame hangs evenly. For example, such frames may be suspended about 1′ to about 4′ from the ceiling of a porch and planted with flowers or other annuals.

Because the wire frames of a hanging basket are spread apart and open, a liner must be placed into the basket to hold the soil medium. This liner is typically shaped from coco fiber, a coconut byproduct. Coco fiber is very porous, allowing water to pour through, yet will contain soil medium so that a plant may grow. The roots of a plant will grow into the coco fiber. However, the coco fiber is biodegradable and will fall apart within a few months. Additionally, birds or other critters will tear and carry off portions of the coco fiber to use in nests. Thus, to keep a plant for any length of time, especially for over a year, or more than one long season, the liner holding the plant's root structure has to be reformed and replaced back into the hanging basket. These deficiencies prompt the need for a hanging plant growing apparatus with a liner that retains growing medium while also being porous and non-biodegradable.

### SUMMARY

In accordance with the present invention, a hanging plant growing apparatus is provided which overcomes the deficiencies described above, and has other advantages.

In one embodiment, a hanging plant growing apparatus is provided. The hanging plant growing apparatus comprises a hemispherical frame, three or more suspension lines, a hanging element, and a hemispherical non-biodegradable liner. The hemispherical frame defines an interior having an upper ring. The upper ring defines an upper opening. The three or more suspension lines extend upwardly from the upper ring. Each of the three or more suspension lines has a first end and a second end. The second end secures to the upper ring. The first end of each of the three or more suspension lines secures to the hanging element.

The hemispherical non-biodegradable liner nests in the interior of the hemispherical frame and has sufficient rigidity to maintain its hemispherical shape when filled with a growing medium. The hemispherical non-biodegradable liner has a plurality of pores extending from an inner surface of the hemispherical non-biodegradable liner to an outer surface of the hemispherical non-biodegradable liner. The plurality of pores have a diameter sufficient to retain the growing medium within the hemispherical non-biodegradable liner and allow the release of a fluid.

In another embodiment, a hanging planter apparatus is provided. The hanging planter apparatus comprises a frame and a non-biodegradable fabric liner having sufficient rigidity to maintain its shape when filled with a growing medium. The frame has an open top, a bottom, and a plurality of curved spaced apart frame members extending from the bottom to the open top. The open top, bottom, and plurality of curved spaced apart frame members define a frame interior. The non-biodegradable fabric liner has a plurality of pores throughout and is shaped to nest in the frame interior.

### BRIEF DESCRIPTION OF THE DRAWINGS

The drawings included with this application illustrate certain aspects of the embodiments described herein. However, the drawings should not be viewed as exclusive embodiments. The subject matter disclosed is capable of considerable modifications, alterations, combinations, and equivalents in form and function, as will occur to those skilled in the art with the benefit of this disclosure.

FIG. 1 is a top perspective view of a hanging plant growing apparatus in accordance with one embodiment of the present disclosure.

FIG. 2 is a bottom perspective view of a hanging plant growing apparatus in accordance with one embodiment of the present disclosure.

FIG. 3 is a top perspective view of a liner of a hanging plant growing apparatus in accordance with one embodiment of the present disclosure.

FIG. 4 is a top view of a hanging plant growing apparatus in accordance with one embodiment of the present disclosure.

FIG. 5 is a bottom view of a hanging plant growing apparatus in accordance with one embodiment of the present disclosure.

FIG. 6 is a cross-sectional side view of a hanging plant growing apparatus in accordance with one embodiment of the present disclosure.

FIG. 7 is a top perspective view of a hanging plant growing apparatus with a liner folded over the sidewalls of the container in accordance with one embodiment of the present disclosure.

### DETAILED DESCRIPTION

The present disclosure may be understood more readily by reference to these detailed descriptions. For simplicity and clarity of illustration, where appropriate, reference numerals may be repeated among the different figures to indicate corresponding or analogous elements. In addition, numerous specific details are set forth in order to provide a thorough understanding of the various embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

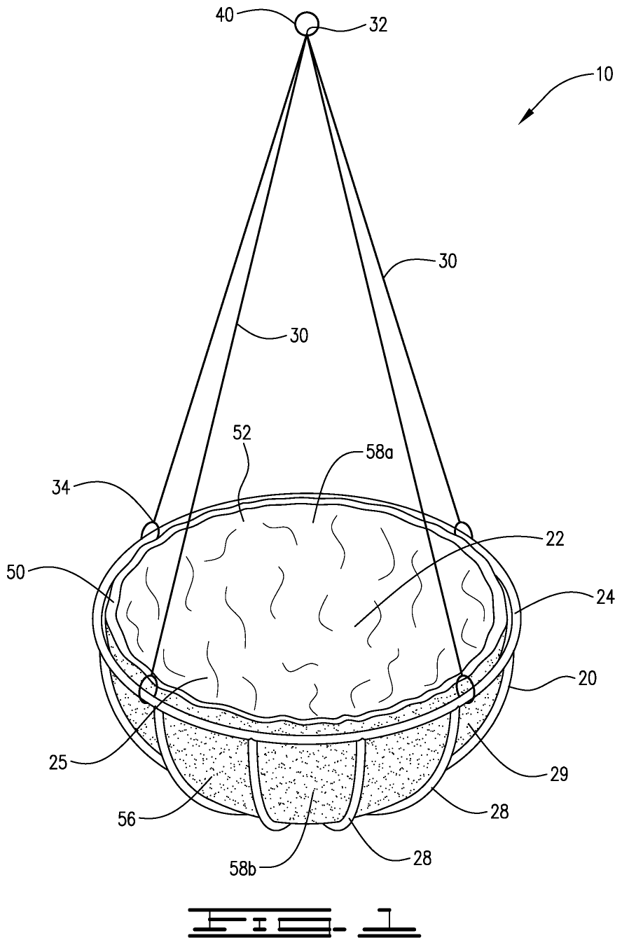

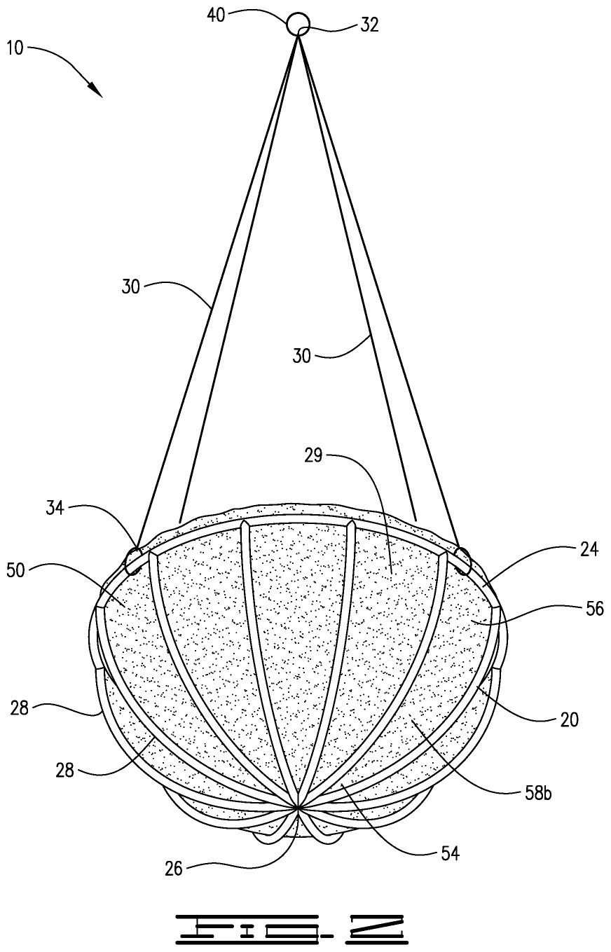

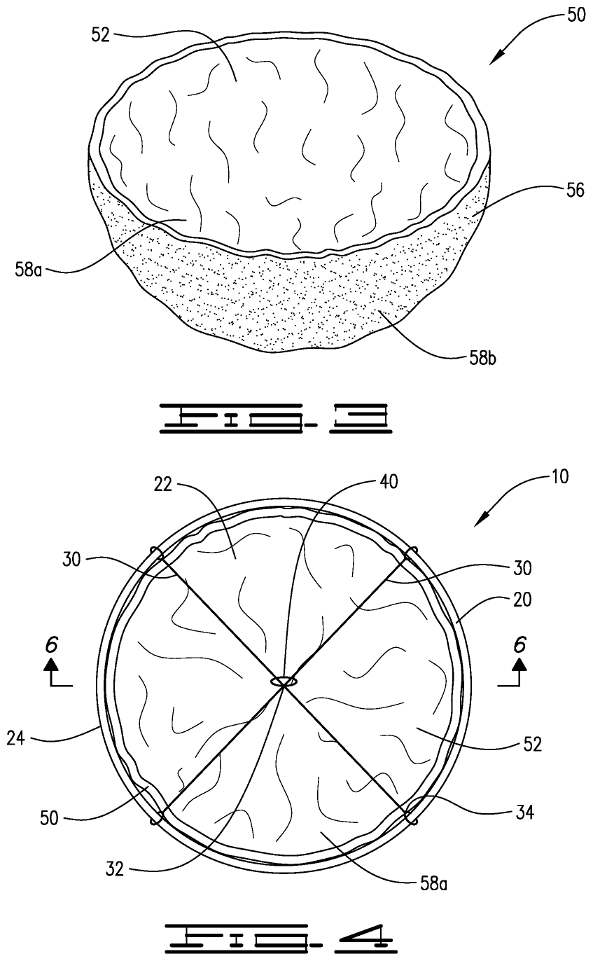

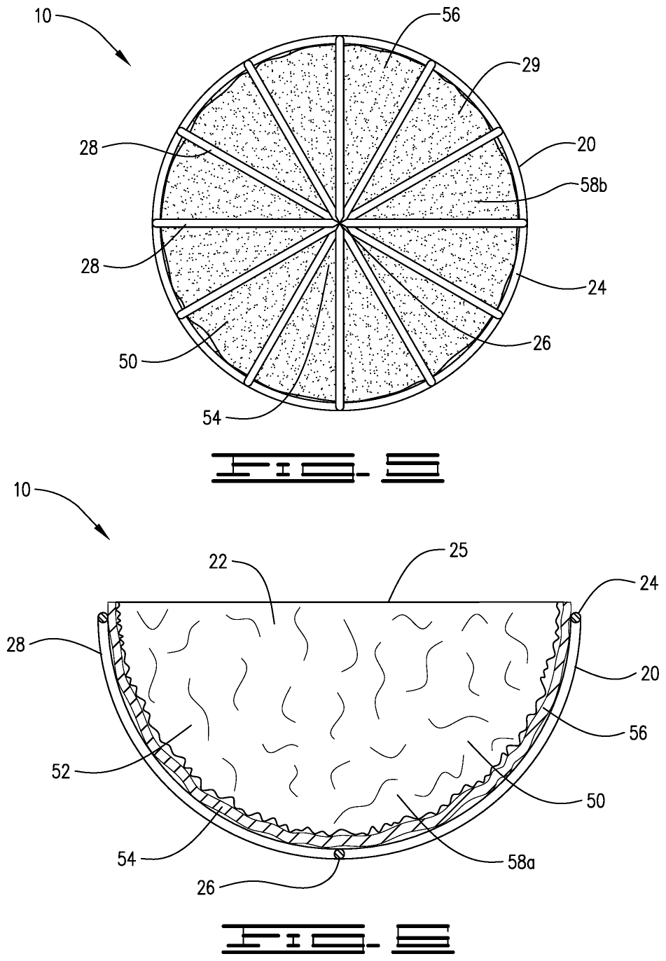

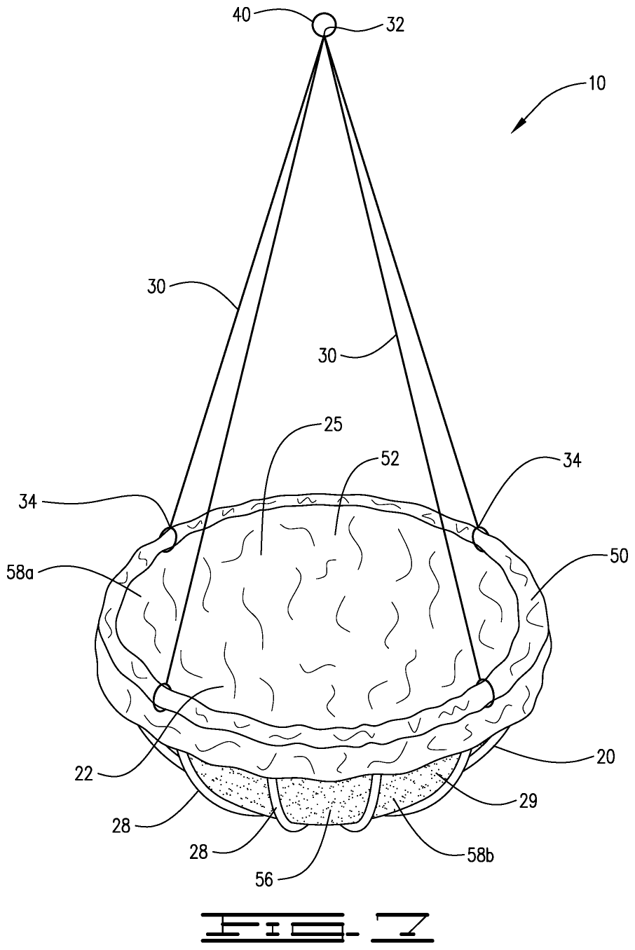

Referring now to FIGS. 1-7 generally, the hanging plant growing apparatus of the present disclosure is illustrated and generally designated by the numeral 10. As shown by the drawings, the general form of hanging plant growing apparatus 10 includes a frame 20, one or more suspension lines 30, a hanging element 40, and a liner 50. To provide for fluid movement through liner 50, liner 50 has a plurality of pores. In some embodiments, as shown in FIGS. 1-7, frame 20 has a hemispherical shape. However, one skilled in the art will understand that frame 20 can be any number of geometrical shapes including conical and cubical.

Frame 20 defines an interior 22 and has an upper ring 24 defining upper opening 25. Interior 22 defines a volume of frame 20. For example, interior 20 may define a volume from about 1.89 liters to about 37.85 liters. In some embodiments, frame 20 further includes a lower ring 26 spaced downwardly from upper ring 24. Upper ring 24 has a first diameter and lower ring 26 has a second diameter. The first diameter is greater than the second diameter. Connecting upper ring 24 and lower ring 26 is a plurality of circumferentially spaced frame members 28 curving radially outward from lower ring 26. Such configuration defines interior 22 of frame 20 and provides for a hemispherical shape of frame 20.

In such embodiments, the spaced distance between each of frame members 28 creates air gaps 29. Air gaps 29 are filled when liner 50 nests within frame 20. Liner 50 has sufficient rigidity to maintain a hemispherical shape within frame 20 when filled with a growing medium. The plurality of pores throughout liner 50 allow fluid movement out of liner 50. Such configuration allows for suspension of frame 20 while retaining growing medium and plants.

In some embodiments, frame 20, including upper ring 24, lower ring 26, and frame members 28, is comprised of a rigid material. The rigid material allows frame 20 to support liner 50 when filled with a growing medium without bending or flexing. For example, wire, plastic, metal, and galvanized metal are suitable rigid materials for frame 20.

Suspension lines 30 extend upwardly from upper ring 24. In some embodiments, as shown in FIGS. 1, 2, 4, and 7, three or more suspension lines 30 extend upwardly from upper ring 24. Suspension lines 30 have a first end 32 and a second end 34. Second end 34 secures suspensions lines 30 to upper ring 24. First end 32 extends upwardly from upper ring 24 and secures suspension lines 30 to hanging element 40. Such configuration allows for suspension of frame 20 from, for example, a porch, a balcony, or from the ceiling. For example, hanging element 40 may be a ring, a hook, or any other hanging element suitable for securing first end 32 of suspension lines 30 and suspending frame 20. One skilled in the art will understand the type of hanging element 40 is dependent on the application, i.e., whether inside or outside and the weight of growing medium in hanging plant apparatus 10.

In some embodiments, suspension lines 30 are spaced equidistantly around upper ring 24 such that frame 20 is level when suspended. The length of suspension lines 30 may be adjusted according to the application. For example, in some embodiments, each of suspension lines 30 is one foot in length such that, when suspended, frame 20 hangs one foot down from the ceiling. In other embodiments, each of suspension lines 30 is four feet in length such that, when suspended, frame 20 hangs four feet down from the ceiling. Suspension lines 30 may be adjustable such that, depending on the application, the height frame 20 hangs from the floor may be adjusted accordingly. One skilled in the art will understand that length of suspension lines 30 depends on the application and aesthetics of a room or area.

Liner 50 lines and nests in interior 22 of frame 20 through upper opening 25 to restrict the loss of soil and other growing media through frame 20. Liner 50 comprises a liner interior 52 defined by a bottom 54 and an at least one upwardly projecting sidewall 56. Bottom 54 and sidewall 56 have inner surfaces 58A and outer surfaces 58B.

Typically, liner 50 is a non-biodegradable fabric. Bottom 54 and sidewall 56 are formed from a single piece of fabric or from two or more pieces of fabric. In some embodiments, the type of fabric used for bottom 54 may be different than the fabric used for sidewall 56. The plurality of pores throughout liner 50 provides air and water permeability through liner 50. The pores extend from inner surfaces 58A of bottom 54 and sidewall 56 to outer surfaces 58B of bottom 54 and sidewall 56 such that liner 50 is air and water permeable. Pores having diameters no larger than one millimeter will provide the desired air and water permeability while also providing the desired retention of soil and other media within liner interior 52 of liner 50. Fluid permeability allows liner 50 to release heat buildup, while also permitting moisture movement through liner 50. These characteristics allow plant components to breathe while in liner interior 52.

Suitable types of fabric for liner 50 include porous, non-woven, needle-punched fabrics. The porous, non-woven, needle-punched fabrics are comprised of fibers which are tangled and knotted as a result of being needle punched. This creates a rough or fuzzy surface capable of trapping, or catching plant roots, but restricts and curtails penetration of the fabric by the roots. The tangled and knotted fibers further provide the additional benefit of entangling plant roots and preventing root circling. In some embodiments, outer surfaces 58B of bottom 54 and sidewall 56 have been heat bonded to create a smooth surface which provides stiffness to bottom 54 and sidewall 56. In such embodiments, inner surfaces 58A of bottom 54 and sidewalls 56 remain rough or fuzzy, such that the roots of a growing plant may be trapped and directed back into liner interior 52.

A suitable type of needle punched fabric for liner 50 is formed of staple cut fibers. The fabric is formed using fibers of polyolefin, polyester, polyamide or mixtures thereof. A staple cut fiber fabric suitable for use as liner 50 may be a heavy, for example about 203.43 grams per meter squared or heavier, fabric formed of polypropylene staple fibers which is strongly heat bonded on one side. For example, non-woven staple-cut polypropylene is a suitable fabric for liner 50.

Heavy needle punched fiber fabrics formed of continuous fibers are also suitable as liner 50. For example, non-woven needle-punched fabrics formed of continuous polyolefin fibers, polyester fibers and/or polyamide fibers can be used such as non-woven polypropylene. As in the case of staple fiber fabrics, the continuous fiber fabrics are preferably about 203.43 grams per meter squared or heavier and are fused by heating after being tangled and knotted by needle punching. The heavier, fused fabric provides strength for resisting root penetration and for resisting the enlargement of those roots that do penetrate the material.

Another material suitable for use as liner 50 is formed of woven continuous fibers. The woven continuous fibers form a substrate and, prior to being needle punched, one or more layers of staple fibers are placed on the substrate. The staple fibers and substrate are then needle punched, whereby the staple fibers are attached to one side of the substrate forming a highly rough or fuzzy surface thereon.

In some embodiments, liner 50 is comprised of a heavy fabric which has been tangled and knotted by needle punching. The tangled and knotted fabric increases strength of the fabric and promotes root pruning. For example, the mass of the fabric may range from about 67.81 grams per meter squared to about 508.59 grams per meter squared. Some of the root tips growing within liner interior 52 will not penetrate liner 50 and will root prune or laterally branch when the mass of the fabric used for liner 50 is within such range. Other roots may slightly penetrate liner 50 and become exposed to the atmosphere. These roots will air root prune, branching laterally inside liner interior 52. Increased strength can be imparted to liner 50 by heat bonding the fibers on outer surfaces 58B. Because the roots are captured by liner 50, the apical dominance of the roots that encounter liner 50 is stopped, and lateral root branching, or root pruning, will occur within liner interior 52. A fibrous root system within liner interior 52 is created. Because of the root branching, which takes place in liner interior 52, the plant, if transplanted, will re-establish itself and anchor itself quickly and effectively.

In some embodiments, the mass of the fabric used for bottom 54 and sidewall 56 is the same. In other embodiments, the mass of the fabric used for bottom 54 is greater than the mass of the fabric used for sidewall 56. Greater mass in the fabric used for bottom 54 allows for a more defined and structured bottom 54.

In some embodiments, as shown in FIGS. 1, 2, and 6, the height of frame 20 and sidewall 56 are about the same length. In other embodiments, as shown in FIG. 7, the length of sidewalls 56 is greater than the height of frame 20. For example, the length of sidewall 56 may be two or more inches longer than the height of frame 20. The increased length of sidewall 56 allows for sidewall 56 to be folded over upper ring 24 of frame 20 to provide a more secure, snug interaction between liner 50 and frame 20. Additionally, the longer sidewall 56 prevents liner 50 from collapsing into itself and for additional stability as growing medium is poured and plants placed into hanging plant growing apparatus 10.

In additional embodiments, as shown in FIGS. 1, 2, 4, 5, and 6, hanging plant growing apparatus 10 comprises a hemispherical frame 20, three or more suspension lines 30, a hanging element 40, and a hemispherical non-biodegradable liner 50. Hemispherical frame 20 defines an interior 22 and has an upper ring 24. Upper ring 24 defines an upper opening 25. Suspension lines 30 extend upwardly from upper ring 24. Each of suspension lines 30 has a first end 32 and a second end 34. Second end 34 secures suspension lines 30 to upper ring 24.

Hanging element 40 provides for suspension of hemispherical frame 20. For example, hanging element 40 allows for suspension of hemispherical frame 20 from the ceiling of a porch or balcony. First end 32 secures suspension lines 30 to hanging element 40. Hemispherical non-biodegradable liner 50 nests in the interior of hemispherical frame 20 and has sufficient rigidity to maintain its hemispherical shape when filled with a growing medium. Hemispherical non-biodegradable liner 50 has a bottom 54, an upwardly projecting sidewall 56, an inner surface 58A, and an outer surface 58B. A plurality of pores extend from inner surface 58A to outer surface 58B. The plurality of pores have a diameter sufficient to retain the growing medium within hemispherical non-biodegradable liner 50 and allow the release of a fluid such as water.

Although the disclosed invention has been shown and described in detail with respect to a preferred embodiment, it will be understood by those skilled in the art that various changes in the form and detailed area may be made without departing from the spirit and scope of this invention as claimed. Thus, the present invention is well adapted to carry out the object and advantages mentioned as well as those which are inherent therein. While numerous changes may be made by those skilled in the art, such changes are encompassed within the spirit of this invention as defined by the appended claims.

What is claimed is:

1. A hanging plant growing apparatus comprising:
a hemispherical frame defining an interior and having an upper ring, the upper ring defining an upper opening;
three or more suspension lines extending upwardly from the upper ring, each of the three or more suspension lines having a first end and a second end, wherein the second end of the three or more suspension lines is secured to the upper ring;
a hanging element, the first end of the three or more suspension lines being secured to the hanging element;
a hemispherical non-biodegradable liner nested in the interior of the hemispherical frame and having sufficient rigidity to maintain its hemispherical shape when filled with a growing medium, the hemispherical non-biodegradable liner having a bottom and an upwardly projecting sidewall; and
a plurality of pores extending from an inner surface of the hemispherical non-biodegradable liner to an outer surface of the hemispherical non-biodegradable liner, the plurality of pores having a diameter sufficient to retain the growing medium within the hemispherical non-biodegradable liner and allow the release of a fluid.

2. The hanging plant growing apparatus of claim 1, the hemispherical frame further comprising:
the upper ring having a first diameter;
a lower ring spaced downwardly from the upper ring, the lower ring having a second diameter, wherein the first diameter is greater than the second diameter; and
a plurality of circumferentially spaced frame members configured to connect the upper ring and the lower ring, the plurality of circumferentially spaced frame members curving radially outward from the lower ring.

3. The hanging plant growing apparatus of claim 2, wherein the upper ring, the lower ring, and the plurality of circumferentially spaced frame members are comprised of a rigid material.

4. The hanging plant growing apparatus of claim 3, wherein the rigid material is selected from the group consisting of wire, plastic, metal, galvanized metal.

5. The hanging plant growing apparatus of claim 1, wherein the three or more suspension lines are equidistantly spaced around the upper ring.

6. The hanging plant growing apparatus of claim 1, wherein the hemispherical non-biodegradable liner is comprised of a fabric.

7. The hanging plant growing apparatus of claim 6, the fabric having a mass ranging from about 67.81 grams per meter squared to about 508.59 grams per meter squared.

8. The hanging plant growing apparatus of claim 6, wherein the fabric is selected from the group consisting of non-woven polypropylene and non-woven staple-cut polypropylene.

9. The hanging plant growing apparatus of claim 8, the fabric having a mass ranging from about 67.81 grams per meter squared to about 508.59 grams per meter squared.

10. The hanging plant growing apparatus of claim 1, the interior having a volume ranging from about 1.89 liters to about 37.85 liters.

11. The hanging plant growing apparatus of claim 1, the interior having a volume of about 1.89 liters.

12. The hanging plant growing apparatus of claim 1, the interior having a volume of about 37.85 liters.

13. The hanging plant growing apparatus of claim 1, the hemispherical non-biodegradable liner having a first length and the hemispherical frame having a second length, wherein the first length is longer than the second length such that the hemispherical non-biodegradable liner folds over the upper ring of the hemispherical frame providing additional stability to the hemispherical non-biodegradable liner when filled with the growing medium.

14. The hanging plant growing apparatus of claim 1, the inner surface of the hemispherical non-biodegradable liner having a plurality of tangled and knotted fibers suitable for entangling plant roots and preventing root circling.

15. The hanging plant growing apparatus of claim 1, each of the plurality of pores having a diameter less than one millimeter.

16. A hanging planter apparatus comprising:
a frame having an open top, a bottom, and a plurality of curved spaced apart frame members extending from the bottom to the open top, wherein the open top, the bottom, and the plurality of curved spaced apart frame members define a frame interior; and
a non-biodegradable fabric liner having a plurality of pores throughout, the non-biodegradable fabric liner shaped to nest in the frame interior, wherein the non-biodegradable fabric liner has sufficient rigidity to maintain its shape when filled with a growing medium.

17. The hanging planter apparatus of claim 16, wherein the frame is configured to be suspended in the air with a suspension element, the suspension element comprising:
one or more suspension lines extending upwardly from the open top, each of the one or more suspension lines having a first end and a second end, wherein the second end of the one or more suspension lines is secured to the frame; and
a hanging element, wherein the first end of the one or more suspension lines is secured to the hanging element.

18. The hanging planter apparatus of claim 16, wherein the fabric liner is comprised of a fabric selected from the group consisting of non-woven polypropylene and non-woven staple-cut polypropylene.

19. The hanging planter apparatus of claim 16, the non-biodegradable fabric liner having a first length and the plurality of curved spaced apart frame members having a second length, wherein the first length is longer than the second length such that the non-biodegradable fabric liner folds over the open top to provide additional stability to the non-biodegradable fabric liner when filled with the growing medium.

20. The hanging planter apparatus of claim 16, the non-biodegradable fabric liner having an interior surface and an outer surface, wherein the interior surface has a plurality of tangled and knotted fibers suitable for entangling plant roots and preventing root circling.
